(19) United States
(12) Patent Application Publication
(10) Pub. No.: US 2016/0208206 A1
(43) Pub. Date: Jul. 21, 2016

(54) MATURATION APPARATUS AND MONITORING METHODS

(71) Applicant: M SQUARED LASERS LIMITED, Glasgow (GB)

(72) Inventors: John NICHOLLS, Glasgow (GB); Graeme MALCOLM, Glasgow (GB)

(73) Assignee: M squared Lasers Limited

(21) Appl. No.: 14/914,018

(22) PCT Filed: Sep. 10, 2014
(86) PCT No.: PCT/GB2014/052739

§ 371 Date: Feb. 24, 2016

(30) Foreign Application Priority Data
Sep. 10, 2013 (GB) 1316104.7

(51) Int. Cl. C12H 1/22

(52) U.S. Cl. CPC C12H 1/22

(57) ABSTRACT

The invention provides a maturation apparatus and associated method that reduces fluid loss from one or more casks during a maturation process by sealably enclosing the casks in an intermodal container. The intermodal container provides an expansion volume to receive fluid vapour from the casks which assists in reducing product loss via evaporation and in reducing the problematic effects associated with fungi that often form in the vicinity of a distillery or other spirit maturation facilities. The maturation apparatus may further comprise a vapour detection system and or an environmental control system. The use of intermodal containers within the maturation apparatus provides a number of significant advantages for the transportation and storage of the casks during the maturation process.

The present invention relates to apparatus and methods for use in maturation processes, and in particular apparatus and methods for reducing and monitoring fluid loss from one or more casks during a maturation process.

### BACKGROUND OF THE INVENTION

Scotch malt whisky production involves several stages, the most important of which is arguably the maturation process by which new-make whisky is matured for several years in wooden casks stored within large warehouses of a distillery.

Whisky is typically ˜60% water, ˜40% ethanol (and ˜0.1% other constituents), when it is casked, but during the maturation process (which typically takes ten to twenty years) a proportion of the fluid volume in the cask is lost to the atmosphere. This is affectionately referred to in the trade as the “angels' share”.

The angels' share is, in Scotland, typically around 2% volume per annum. Elsewhere in the world the loss can be more than 20% per annum. Some whisky producers may have tens of millions of whisky casks undergoing maturation at any one time so these losses are clearly significant. In fact, the angels' share is reported to cost on the order of 10-15% of the overall production cost.

As is recognised in the art, the whisky vapour that forms the angels' share is highly flammable. A build up of such a vapour within a confined space would therefore produce a potentially highly explosive environment. It is for this reason that mobile phones etc. are prohibited within these warehouses. To reduce the build up of the angels' share, and hence the risk of explosion, a warehouse is normally provided with a venting means so as to allow the angels' share to escape into the surrounding environment. In US patent publication number US 2010/0275784 the venting means is extended to comprise an environmental control system so as to fully regulate the environment of the warehouses within which the whisky casks are stored during the maturation process.

Wines, cognacs, armagnacs, rums, sherries, ports, whiskeys (e.g. Bourbon) and beers may also be matured in barrels (as may balsamic vinegar), and the angels' share loss problem is also known to affect these maturation processes (to lesser or greater extents). This is therefore a wide reaching problem, and a solution that at least partially solves the problem would provide major economic benefits.

A secondary problem associated with the angels' share loss is the formation of whisky fungus. Whisky fungus or Baudoinia compniacensis (a type of sac fungus) is a black fungus that readily forms upon surfaces located in the vicinity of a distillery or other spirit maturation facility. This fungus is a habitat coloniser with a preference for airborne alcohol thus making the areas surrounding a distillery an ideal environment for it to thrive. It causes staining and damage to any buildings or vehicles it grows on which can have a negative effect on the area, not least in reducing property values. Owners also need to regularly clean their buildings and vehicles with corrosive, abrasive pressure washers and chemicals, which can cause further damage to their property. More recent studies suggest that the presence of black fungus may also be detrimental to the heath of those in the areas surrounding the distillery.

It is therefore desirable to be able to reduce or prevent this lost volume of product so as to reduce production costs and to reduce the problematic effects associated with fungi that often form in the vicinity of a distillery or other spirit maturation facilities.

Experiments have been conducted in which individual whisky casks have been shrink-wrapped in order to prevent such fluid loss. While fluid loss is eliminated (or significantly reduced) by such processes there is a corresponding elimination (or significant reduction) in air ingress which is believed to negatively affect the maturation process and hence the taste of the final product.

An alternative method and apparatus to reduce fluid loss from a cask during a maturation process is described in detail within international patent application number PCT/GB2012/051621. The disclosed apparatus comprises a bespoke vessel employed to sealably enclose the cask and thus provide an expansion volume around the cask in order to provide a means for accumulating the vapour leakage. A light source and detector based monitoring system can then be employed to determine a relative transmission of the light through the expansion volume and thus provided a measure of the fluid loss from the cask.

In practice the described apparatus of international patent application number PCT/GB2012/051621 is not particularly mobile. Furthermore, the bespoke nature of the described apparatus also makes them expensive to produce and thus adds to the overall production cost of the whisky.

In view of the foregoing, it is an object of at least one embodiment of the present invention to provide an alternative apparatus that can reduce or prevent fluid loss during a maturation process, and a corresponding method.

In the description that follows the term intermodal container (also known as cargo carrying units (CCU), a freight container, an ISO container, a shipping container, a hi-cube container, a box, a conex box or sea can) refers to a standardised reusable steel box used for the safe, efficient and secure storage and movement of materials and products within a global containerised intermodal freight transport system. The term “intermodal” indicates that the container can be moved from one mode of transport to another (e.g. from ship, to rail, to truck) without unloading and reloading the contents of the container. The length of the containers, which each have a unique ISO 6346 reporting mark, varying from 8 to 56 feet (2.438 to 17.069 m) and heights from 8 feet (2.438 m) to 9 feet 6 inches (2.896 m).

### SUMMARY OF THE INVENTION

According to a first aspect of the invention, there is provided a maturation apparatus for use in a maturation process of a fluid contained within one or more casks, the maturation apparatus comprising an intermodal container having one or more doors and one or more sealing means wherein the one or more sealing means provide an airtight seal for an internal volume of the intermodal container when the one or more doors are in a closed position.

When the doors of the intermodal container are closed the intermodal container provides an expansion volume (i.e. the internal volume not occupied by fluid filled casks) into which vapour (e.g. ethanol vapour) from the fluid may expand. Once filled by the vapour, the expansion volume prevents further evaporation of the fluid from the casks and so significantly reduces or prevents the lost volume of product known as the angels' share. Reducing the angel's share also assists in reducing the problematic effects associated with fungi that often form in the vicinity of a distillery or other spirit maturation facilities. Adapting one or more intermodal containers to form the maturation apparatus also simplifies the processes of transporting and storing the casks during the maturation process.

It is preferable for the one or more doors to be fitted with a lock. The lock provides a means for restricting unauthorised access to the internal volume of the intermodal container. Most preferably the maturation apparatus is fitted with an anti-tampering device. Incorporation of an anti-tampering device provides a means for detecting any unauthorised opening of the one or more doors during the maturation process.

Optionally the maturation apparatus further comprises a vapour detection system that provides a means for monitoring the internal volume of the intermodal container.

The vapour detection system may comprise a light source and a detector wherein the detector is arranged to receive light emitted from the light source following its propagation through the internal volume of the intermodal container.

The vapour detection system may comprise one or more mirrors arranged to increase the absorption path length between the light source and the detector.

Optionally the light source comprises a mid-infrared laser source.

The detector may comprise a power meter. Alternatively the detector comprises a spectrometer or a spectrophotometer.

Preferably the vapour detection system is housed within the intermodal container. This is preferable so as to reduce the footprint of the maturation apparatus.

Optionally the maturation apparatus further comprises an environmental control system that provides a further means for monitoring internal volume of the intermodal container.

The environmental control system may comprise a pressure gauge that provides a means for measuring the pressure of the internal volume of the intermodal container. Preferably the environmental control system further comprises a venting valve that provides a means for adjusting the pressure of the internal volume of the intermodal container.

The environmental control system may further comprise one or more gas or vapour sources in fluid communication with the internal volume of the intermodal container. In this way controlled amount of gases or vapours can be introduced to the internal volume of the intermodal container.

The environmental control system may comprise a thermometer that provides a means for measuring the temperature of the internal volume of the intermodal container. Preferably the environmental control system further comprises a temperature regulator that provides a means for adjusting the temperature of the internal volume of the intermodal container. Optionally the temperature regulator comprises a water cooler.

Preferably the environmental control system is housed within the intermodal container.

This is preferable so as to reduce the footprint of the maturation apparatus.

The maturation apparatus preferable comprises a feedback loop between the vapour detection system and the environmental control system. This feedback loop allows for the automated control of the environmental control system in response to the readings of the vapour detection system.

The maturation apparatus may further comprise a power source arranged to supply power to the one or more components of the apparatus. Most preferably the power source comprises a renewable power source.

Optionally, the maturation apparatus further comprises one or more layers of an insulating material to provide a means for passively regulating the temperature within the intermodal container.

The maturation apparatus may also comprise a space filler. The function of the space filler is to fill at least part of the internal space of the intermodal container not occupied by the whisky casks. The space filler may comprise an inflatable membrane.

According to a second aspect of the present invention there is provided a method of maturating a fluid contained within one or more casks the method comprising sealing the one or more casks within one or more intermodal containers.

The method of maturating a fluid may further comprise monitoring the internal volume of the one or more intermodal containers during the maturation process.

The method of maturating a fluid may further comprise the deployment of one or more space fillers to fill at least part of the internal volume of the intermodal container.

Sealing the one or more casks within the one or more intermodal container units may comprise locating the one or more casks within the one or more intermodal containers and then closing one or more doors of the one or more intermodal containers.

The sealing of the one or more casks may comprise activating a lock for the one or more doors. Additionally, the sealing of the one or more casks may comprise activating an anti-tampering device.

Monitoring the internal volume of the one or more intermodal containers during the maturation process may comprise monitoring a level of a vapour present within the one or more intermodal containers.

Optionally the monitoring the level of the vapour present within the one or more intermodal containers comprises determining a relative transmission or absorption of a light source propagating within the one or more intermodal containers.

Monitoring the internal volume of the one or more intermodal containers during the maturation process may comprise monitoring the environmental conditions within the one or more intermodal containers.

Optionally the monitoring of the environmental conditions within the one or more intermodal containers may comprise measuring and regulating the pressure within the one or more intermodal containers.

Optionally the monitoring of the environmental conditions within the one or more intermodal containers may comprise measuring and regulating the temperature within the one or more intermodal containers.

Optionally the monitoring of the environmental conditions within the one or more intermodal containers may comprise measuring and regulating the humidity within the one or more intermodal containers.

Optionally the monitoring of the environmental conditions within the one or more intermodal containers may comprise measuring and regulating the atmospheric composition within the one or more intermodal containers.

The method of maturating a fluid contained within one or more casks may further comprise transporting and or stacking the one or more sealed intermodal containers.

Embodiments of the second aspect of the invention may include one or more features corresponding to features of the first aspect of the invention or its embodiments, or vice versa.

### BRIEF DESCRIPTION OF THE DRAWINGS

There will now be described, by way of example only, various embodiments of the invention with reference to the drawings, of which:

FIG. 1 illustrates in schematic form a maturation apparatus for storing one or more whisky casks during a maturation process in accordance with an embodiment of the present invention; and

FIG. 2 presents a flow chart of the methodology of the maturation process employed with the maturation apparatus of FIG. 1.

In the description which follows, like parts are marked throughout the specification and drawings with the same reference numerals. The drawings are not necessarily to scale and the proportions of certain parts have been exaggerated to better illustrate details and features of embodiments of the invention.

### DETAILED DESCRIPTION OF PREFERRED EMBODIMENTS

The following example is described in the context of the maturation of whisky within casks, however it will be understood that the invention finds utility in other maturation processes; for example of wine, cognac, armagnacs, rums, sherry, port, whiskey (e.g. Bourbon), beer and balsamic vinegar. Furthermore, while wooden casks are typically employed it is understood that casks made from other materials (such as plastics or metals as increasingly used in wine maturation or clay pots as used in the maturation of Chinese white spirits) shall not fall outside the scope of protection set out herein.

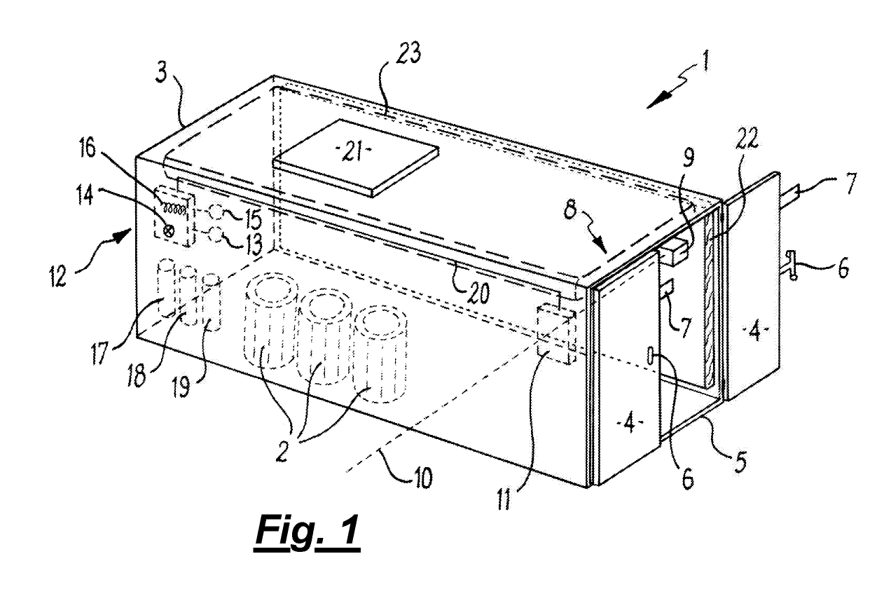

FIG. 1 presents a schematic representation of a maturation apparatus 1 suitable for the maturation of whisky within one or more whisky casks 2 located therein. The maturation apparatus 1 is based on an intermodal container 3 (e.g. a standard twenty foot CCU) that is suitable and certified for international transport and stacking and so provides a relatively simple and secure means for transporting and storing the apparatus. Significantly, however, is the fact that the doors 4 of the intermodal container 3 are provided with a sealing means 5 e.g. a rubber seal. In particular, the sealing means 5 is arranged to provide an airtight seal for the internal volume of the intermodal container 3 when the doors 4 are in their closed position.

The doors 4 of the maturation apparatus 1 may be also be fitted with a lock 6 that provides a means for restricting unauthorised access to the internal volume of the intermodal container 3.

The maturation apparatus 1 may also comprise an anti-tampering device 7 (e.g. a security tape) so that any unauthorised opening of the doors 4 during the maturation process can be detected.

The maturation apparatus 1 may further comprise a vapour detection system 8 that provides a means for monitoring the levels of a vapour within the intermodal container 3. In the presently described embodiment the vapour detection system 8 comprises a light source 9, the light from which is directed through the expansion volume of the intermodal container 3, thus defining an optical path 10 through the intermodal container 3, to a detector 11. In this example the light source is a mid-infrared optical parametric oscillator source outputting 70 mW at approximately 3306 nm, although it will be readily apparent that any other suitable infrared light source may be employed. This particular wavelength coincides with the O—H and C—H stretch absorption bands of ethanol, and accordingly transmission through the intermodal container 3 gives an indication of the presence of ethanol within the intermodal container 3. The detector 11, in this case a laser power meter, is connected to a data logger (not shown), for example a PC with a suitable data acquisition card, to record transmitted power as a function of time.

It is envisaged that an alternative embodiment of the invention the vapour detection system 8 comprises the laser source and power meter housed outside of the intermodal container 3 and two apertures provided on opposite sides of the intermodal container 3. The apertures would then be sealed by way of calcium fluoride (CaF₂) windows affixed thereto, although any suitable material for the windows may be used.

In a further alternative embodiment the vapour detection system 8 one or more mirrors could be incorporated within the vapour detection system 8 so as to increase the absorption path length (and hence, sensitivity) of the system 8. The laser source 9 and the detector 11 may then be located on the same side of the intermodal container 3 thus allowing the intermodal container 3 to be monitored from one side.

In a yet further alternative embodiment the detector 11 of the vapour detection system 8 comprises a spectrometer or spectrophotometer that provides a means for analysing the atmospheric composition within the intermodal container 3. The spectrometer may be of any suitable kind, for example a tuneable diode laser absorption spectrometer or an active infrared hyperspectral imaging system such as the applicant's intra-cavity optical parametric oscillator based system. Thus, a detailed analysis of the composition of the atmosphere within the intermodal container 3 might be determined in real-time.

The apparatus 1 may further comprises an environment control system 12 that provides an additional means for monitoring the internal volume of intermodal container 3. In particular the environment control system 12 allows the pressure within the intermodal container 3 to be measured via a pressure gauge 13 and then adjusted, if necessary, via a venting valve 14. Similarly, the environment control system 12 allows the temperature within the intermodal container 3 to be measured via a thermometer 15 and then adjusted, if necessary, via a temperature regulator 16.

The temperature regulator may comprise a heating element or cooling system (e.g. a water cooler) so as to provide a means for increasing or reducing the temperature within the intermodal container 3.

In order to reduce the foot print of the maturation apparatus it is preferable for the environment control system 12 to be located within the intermodal container 3.

The control system 12 may also be employed to regulate the relative humidity and atmospheric composition via the controlled release of one or more vapours into the internal volume of the intermodal container 3 e.g. from a water vapour 17, an air or oxygen source 18, and or nitrogen vapour source 19. It is envisaged that further substances may be added to the intermodal container 3 during the maturation process to simulate desirable atmospheric conditions. For example, salt water could be injected to simulate the sea air of a shore-side maturation location.

The environment control system 12 may be connected to the vapour detection system 8 via a feedback loop 20.

Power for the various components of the maturation apparatus 1 may be provided by a power source 21. It is preferable for the power source to by a renewable power source e.g. a solar panel or wind turbine.

The walls of the intermodal container 3 may also comprise one or more layers of insulating material 22 so as to provide a means for passively regulating the temperature within the intermodal container 3.

The maturation apparatus may further comprise a space filler 23 the function of which is to fill at least part of the internal volume of the intermodal container 3 not occupied by the whisky casks 2. As shown in FIG. 1, the space filler 23 may be in the form of an inflatable membrane that is inflated after the whisky casks 2 are located within the intermodal container 3. Alternatively, the space filler 23 may comprise an expandable foam or more standard packaging e.g. paper, pieces of polystyrene or sheets of bubble wrap.

The whisky casks 2 are shown stacked vertically within the intermodal container 3, however it will be understood that the casks 2 may sit horizontally or at any other orientation. Furthermore, while the intermodal container 3 is based on a standard twenty foot CCU alternatively sized intermodal containers as known in the art could equally be employed.

Maturation Process

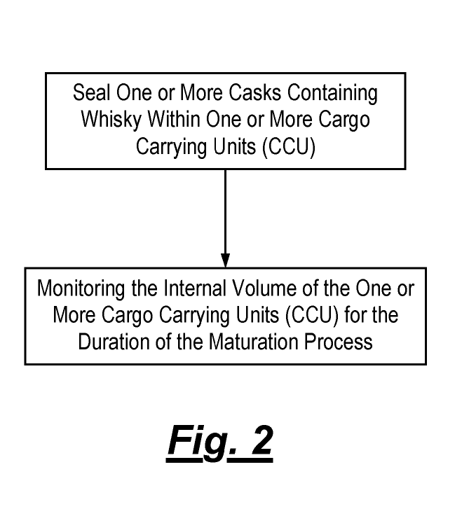

A maturation process for one or more casks containing whisky that employs the maturation apparatus 1 will now be described with reference to FIG. 2.

The first stage of the process is to seal one or more casks 2 containing the whisky within one or more intermodal containers 3. This is achieved by locating the casks 2 within the intermodal containers 3 and then closing the doors 4. As discussed above, the presence of the sealing means 5 renders the intermodal container 3 airtight when the doors 4 are secured in their closed position. At this stage the intermodal container 3 provides an expansion volume (i.e. the internal volume not occupied by the casks 2) into which vapour (e.g. ethanol vapour) from the casks 2 may expand.

The second stage involves monitoring the internal volume of the one or more intermodal containers 3 for the duration of the maturation process.

The maturation process may further comprise the deployment of a space filler 23 so as to fill at least part of the internal volume of the intermodal container 3 not occupied by the whisky casks 2. Deploying a space filler 23 allows for equilibrium within the internal volume of the container to be more rapidly achieved while reducing the amount of ethanol present within the intermodal container 3. Reduced levels of ethanol has obvious health and safety benefits for storage of the whisky casks 2 and when the doors 4 are required to be opened for unloading of the whisky casks 2 at the end of the maturation process.

Monitoring the internal volume of intermodal containers 3 may comprise monitoring the level of a vapour (e.g. ethanol) present within the intermodal containers 3 by employing the above described vapour detection system 8.

In use, a background level for determining relative transmission or absorption is obtained without the casks 2 being present in the intermodal containers 3, although the background measurement could be taken immediately after the casks 2 are placed in the intermodal containers 3 (before or after the doors 4 are closed) before any significant ethanol leakage occurs. Subsequently, the doors are closed thus sealing the intermodal containers 3. As noted above, ethanol will leak out of the casks 2 in the form of ethanol vapour, which results in absorption of the laser light within the intermodal containers 3. This absorption is detected by way of a reduction in optical power through the intermodal containers 3, as monitored by the detector 11.

As will be appreciated by the skilled reader, the vapour detection system 8 can be employed to provide a means for monitoring the presence, and ongoing integrity, of the sealing means 5. A slow drop off in the absorption level of the laser light would be indicative of an integrity failure of the sealing means 5. A sudden drop off in the absorption level of the laser light would however be indicative of a more significant change to the level of ethanol within the internal volume. This may be a result of one or both of the doors 4 having been opened. The vapour detection system 8 can therefore also be employed as an alternative anti-tampering device for the maturation apparatus 1.

Monitoring the internal volume of intermodal containers 3 may further comprise monitoring the environmental conditions within the intermodal containers 3, and particularly the expansion volume. Employing the maturation apparatus 1 described above allows for the regulation of the relative humidity and atmospheric composition within the intermodal containers 3 to be achieved automatically or via manual intervention. This automatic intervention may take advantage of the feedback loop 20 between the environmental control system 12 and the vapour detection system 8.

The control of the internal volume of the intermodal containers 3 may comprise maintaining the same environmental conditions throughout an entire maturation process or alternatively varying the environmental conditions as and when required. By controlling the environmental conditions the maturation process of the whisky can also be controlled.

In a particular embodiment of the invention, the control system 12 is employed to maintain a small positive atmospheric pressure within the sealed intermodal containers 3. Accordingly, the fluid loss from the casks 2 resulting from the angels' share is minimised while still allowing for air (oxygen) ingress into the casks 2 to allow the whisky to mature properly.

If necessary, the maturation apparatus allows for the intermodal containers 3 to be purged and refilled every few years. Even with regular purging, the anticipated loss to the angels' share will be significantly reduced over the entire maturation process.

By way of example, it is found that the ratio of water loss to ethanol loss from the casks 2 is dependent on the prevailing atmospheric conditions; principally relative humidity and temperature, although other conditions may also have an effect. For example, higher temperatures are found to increase losses of both ethanol and water. Higher humidity results in increased ethanol loss (relative to water) and lower humidity results in increased water loss (relative to ethanol). The maturation apparatus 1 described herein allows these conditions (temperature and relative humidity) to be controlled, thus controlling the maturation process.

One particular use for the control system 12 will be in the event that testing during the maturation process reveals some issue with the whisky that can be remedied by varying the atmospheric conditions. For example, if it was deemed that increased water loss was required, relative humidity could be reduced. In this way, a specific ethanol content can be targeted, particularly during the final stages of the maturation process. This may, for example, be used to increase alcohol content of whisky or to reduce the alcohol content of wine in the final product—as is often required in the industry.

The foregoing description of the invention provides a maturation apparatus 1 and a method that first and foremost prevents fluid loss from the casks 2 once an equilibrium position has been reached within the intermodal containers 3. The addition of vapour detection system 8 also allows the level of ethanol vapour leaking from the casks 2 to be monitored. Optionally, the atmospheric composition can also be monitored and controlled. The described maturation apparatus 1 provides a means to reduce or prevent the angel's share lost volume of product and so help in reducing production costs. This feature also helps to reduce the known problematic effects associated with whisky fungus.

Several significant advantages also extend from the fact that the described maturation apparatus 1 are based on adapted intermodal containers.

In the first instance this feature makes the described maturation apparatus highly portable since the intermodal containers can be efficiently stacked for transport and storage purposes. This allows the described maturation apparatus to be easily deployed at a particular location without the need for a dedicated fixed structure to be constructed. In effect, the maturation apparatus provides for a modular mobile warehouse for controlled storage of the casks contained therein.

It will be appreciated that the maturation apparatus also provide a controlled environment that allows for transportation of the whisky casks contained therein before completion of the maturation process. This feature can be exploited so as to reduce the problematic effects of the formation of whisky fungus around traditional distillery sites. It can also be exploited to allow for early shipping to overseas destinations. Indeed, shipping to such overseas destinations could be carried out shortly after the whisky casks have been stored within the intermodal containers so as to transfer the storage requirements for the casks from the distiller to their respective customer.

The sealed intermodal containers also provide a higher level of protection for the cask from external influences such as airborne pollutants, fire and flooding and theft. It will be appreciated by the skilled reader that the casks can also be redeployed if required e.g. if a particular period of harsh weather is anticipated at a particular location where the intermodal containers have originally been deployed.

The invention provides a maturation apparatus and associated method that reduces fluid loss from one or more casks during a maturation process by sealably enclosing the casks in an intermodal container. The intermodal container provides an expansion volume to receive fluid vapour from the casks which assists in reducing product loss via evaporation and in reducing the problematic effects associated with fungi that often form in the vicinity of a distillery or other spirit maturation facilities. The maturation apparatus may further comprise a vapour detection system and or an environmental control system. The use of intermodal containers within the maturation apparatus provides a number of significant advantages for the transportation and storage of the casks during the maturation process.

Throughout the specification, unless the context demands otherwise, the terms “comprise” or “include”, or variations such as “comprises” or “comprising”, “includes” or “including” will be understood to imply the inclusion of a stated integer or group of integers, but not the exclusion of any other integer or group of integers.

Furthermore, reference to any prior art in the description should not be taken as an indication that the prior art forms part of the common general knowledge.

The foregoing description of the invention has been presented for purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention as defined by the appended claims.

1) A maturation apparatus for use in a maturation process of a fluid contained within one or more casks, the maturation apparatus comprising an intermodal containers having one or more doors and one or more sealing means wherein the one or more sealing means provide an airtight seal for an internal volume of the intermodal container when the one or more door are in a closed position.

2) A maturation apparatus as claimed in claim 1 wherein the one or more doors are fitted with a lock.

3) A maturation apparatus as claimed in claim 1 wherein the maturation apparatus further comprises an anti-tampering device.

4) A maturation apparatus as claimed in claim 1 wherein the maturation apparatus further comprises a vapour detection system that provides a means for monitoring an internal volume of the intermodal container.

5) A maturation apparatus as claimed in claim 4 wherein the vapour detection system comprises a light source and a detector wherein the detector is arranged to receive light emitted from the light source following its propagation through the internal volume of the intermodal container.

6) A maturation apparatus as claimed in claim 5 wherein the light source comprises a mid-infrared laser source.

7) A maturation apparatus as claimed in claim 5 wherein the detector comprises a power meter.

8) A maturation apparatus as claimed in claim 5 wherein the detector comprises a spectrometer or a spectrophotometer.

9) A maturation apparatus as claimed in claim 5 wherein the vapour detection system comprises one or more mirrors arranged to increase the absorption pathlength between the light source and the detector.

10) A maturation apparatus as claimed in claim 4 wherein the vapour detection system is housed within the intermodal container.

11) A maturation apparatus as claimed in claim 11 wherein the maturation apparatus further comprises an environmental control system that provides a means for monitoring internal volume of the intermodal container.

12) A maturation apparatus as claimed in claim 11 wherein the environmental control system comprises a pressure gauge that provides a means for measuring the pressure of the internal volume of the intermodal container.

13) A maturation apparatus as claimed in claim 12 wherein the environmental control system further comprises a venting valve that provides a means for adjusting the pressure of the internal volume of the intermodal container.

14) A maturation apparatus as claimed in claim 11 wherein the environmental control system further comprises one or more gas or vapour sources in fluid communication with the internal volume of the intermodal container.

15) A maturation apparatus as claimed in claim 11 wherein the environmental control system comprises a thermometer that provides a means for measuring the temperature of the internal volume of the intermodal container.

16) A maturation apparatus as claimed in claim 15 wherein the environmental control system further comprises a temperature regulator that provides a means for adjusting the temperature of the internal volume of the intermodal container.

17) A maturation apparatus as claimed in claim 16 wherein the temperature regulator comprises a water cooler.

18) A maturation apparatus as claimed in claim 11 wherein the environmental control system is housed within the intermodal container.

19) A maturation apparatus as claimed in claim 11 wherein the maturation apparatus comprises a feedback loop between the vapour detection system and the environmental control system.

20) A maturation apparatus as claimed in claim 1 wherein the maturation apparatus further comprises a power source arranged to supply power to the one or more components of the apparatus.

21) A maturation apparatus as claimed in claim 20 wherein the power source comprises a renewable power source.

22) A maturation apparatus as claimed in claim 1 wherein the intermodal container further comprises one or more layers of insulation.

23) A maturation apparatus as claimed in claim 1 wherein the maturation apparatus further comprises a space filler that provides a means for occupying at least part of the internal volume of the intermodal container.

24) A maturation apparatus as claimed in claim 23 wherein the space filler comprises an inflatable membrane.

25) A method of maturating a fluid contained within one or more casks the method comprising sealing the one or more casks within one or more intermodal containers.

26) A method of maturating a fluid as claimed in claim 25 wherein the method further comprises monitoring the internal volume of the one or more intermodal containers during the maturation process.

27) A method of maturating a fluid as claimed in claim 25 wherein the method further comprise the deployment of a space filler so as to fill at least part of the internal volume of the intermodal container.

28) A method of maturating a fluid contained within one or more casks as claimed in claim 25 wherein the sealing the one or more casks within the one or more cargo carrying units comprises locating the one or more casks within the one or more intermodal containers and then closing one or more doors of the one or more intermodal containers.

29) A method of maturating a fluid contained within one or more casks as claimed in claim 25 wherein the sealing of the one or more casks comprises activating an anti-tampering device.

30) A method of maturating a fluid contained within one or more casks as claimed in claim 25 wherein the monitoring of the internal volume of the one or more intermodal containers during the maturation process comprises monitoring a level of a vapour present within the one or more intermodal containers.

31) A method of maturating a fluid contained within one or more casks as claimed in claim 30 wherein the monitoring of the level of the vapour present within the one or more intermodal containers comprises determining a relative transmission or absorption of a light source propagating within the one or more intermodal containers.

32) A method of maturating a fluid contained within one or more casks as claimed in claim 25 wherein the monitoring of the internal volume of the one or more intermodal containers during the maturation process comprises monitoring the environmental conditions within the one or more intermodal containers.

33) A method of maturating a fluid contained within one or more casks as claimed in claim 32 wherein the monitoring of the environmental conditions within the one or more intermodal containers comprises measuring and regulating the pressure within the one or more intermodal containers.

34) A method of maturating a fluid contained within one or more casks as claimed in claim 32 wherein the monitoring of the environmental conditions within the one or more intermodal containers comprises measuring and regulating the temperature within the one or more intermodal containers.

35) A method of maturating a fluid contained within one or more casks as claimed in claim 32 wherein the monitoring of the environmental conditions within the one or more intermodal containers comprises measuring and regulating the humidity within the one or more intermodal containers.

36) A method of maturating a fluid contained within one or more casks as claimed in claim 32 wherein the monitoring of the environmental conditions within the one or more intermodal containers comprises measuring and regulating the atmospheric composition within the one or more intermodal containers.

37) A method of maturating a fluid contained within one or more casks as claimed in claim 25 wherein the method further comprise transporting the one or more sealed intermodal containers.

38) A method of maturating a fluid contained within one or more casks as claimed in claim 25 wherein the method further comprise stacking the one or more sealed intermodal containers.

39) (canceled)
